(19) United States
(12) Patent Application Publication
(10) Pub. No.: US 2019/0358957 A1
(43) Pub. Date: Nov. 28, 2019

(54) Wiping Device and Ink-Jet Recording Apparatus

(71) Applicant: Kyocera Document Solutions Inc., Osaka (JP)

(72) Inventors: Takashi Somete, Osaka (JP); Noriaki Furukawa, Osaka (JP); Aiichiro Otana, Osaka (JP); Kenichi Satake, Osaka (JP); Takuma Araki, Osaka (JP); Yasutaka Inui, Osaka (JP); Chikara Ishihara, Osaka (JP); Yuzuru Yuasa, Osaka (JP)

(73) Assignee: Kyocera Document Solutions Inc.

(21) Appl. No.: 16/416,271

(22) Filed: May 20, 2019

(30) Foreign Application Priority Data
May 23, 2018 (JP) 2018-098841
May 23, 2018 (JP) 2018-098842

(51) Int. Cl. B41J 2/165

(52) U.S. Cl. CPC B41J 2/16538; B41J 2/16547

(57) ABSTRACT

A wiping device wipes off ink attached to an ink discharge surface of a recording head. The wiping device includes a wiper. The wiper wipes off ink attached to the ink discharge surface of the recording head. The wiper is formed of a material having elasticity. The wiper includes a blade pressed to the ink discharge surface. The blade has a shape easily deformed in a direction perpendicular to the ink discharge surface.

### INCORPORATION BY REFERENCE

This application is based upon, and claims the benefit of priority from, corresponding Japanese Patent Application Nos. 2018-098841 and 2018-098842, each filed in the Japan Patent Office on May 23, 2018, the entire contents of which are incorporated herein by reference.

### BACKGROUND

Unless otherwise indicated herein, the description in this section is not prior art to the claims in this application and is not admitted to be prior art by inclusion in this section.

There has been proposed an ink-jet recording apparatus that includes a recording head and a cleaning member. The cleaning member is formed into a strip shape. A part of the cleaning member is shaped into a bent state. To wipe off ink attached to a nozzle formation surface of the recording head, the cleaning member is in abutting contact with the nozzle formation surface by an upper end portion so as to deform in a bending direction.

### SUMMARY

A wiping device according to an aspect of the disclosure wipes off ink attached to an ink discharge surface of a recording head. The wiping device includes a wiper. The wiper wipes off ink attached to the ink discharge surface of the recording head. The wiper is formed of a material having elasticity. The wiper includes a blade pressed to the ink discharge surface. The blade has a shape easily deformed in a direction perpendicular to the ink discharge surface.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates one example of a configuration of an ink-jet recording apparatus according to an embodiment of the disclosure;

FIG. 2 obliquely illustrates one example of a configuration of a head unit in the ink-jet recording apparatus;

FIG. 3 illustrates one example of a configuration of a wiping device according to the embodiment;

FIG. 4A and FIG. 4B illustrate one example of a configuration of a wiper according to a first embodiment, FIG. 4A illustrates a side view illustrating one example of the configuration of the wiper, and FIG. 4B illustrates a front view illustrating one example of the configuration of the wiper;

FIG. 5 illustrates a side view illustrating one example of a behavior of the wiper according to the first embodiment;

FIG. 6A and FIG. 6B illustrate one example of a configuration of a wiper according to a second embodiment, FIG. 6A illustrates a side view illustrating one example of the configuration of the wiper, and FIG. 6B illustrates a front view illustrating one example of the configuration of the wiper;

FIG. 7 illustrates a side view illustrating one example of behaviors of the wipers according to the second embodiment;

FIG. 8 illustrates one example of a state where the wipers are caused to move down by a moving mechanism;

FIG. 9 illustrates one example of a state where the wipers are caused to move up by the moving mechanism;

FIG. 10 illustrates one example of a configuration of a wiping device according to the embodiment of the disclosure;

FIG. 11A and FIG. 11B illustrate one example of a configuration of a wiper according to a third embodiment; FIG. 11A illustrates a side view illustrating one example of the configuration of the wiper; and FIG. 11B illustrates a front view illustrating one example of the configuration of the wipe;

FIG. 12 illustrates a side view illustrating one example of a behavior of the wiper according to a third embodiment;

FIG. 13A illustrates a side view illustrating one example of a configuration of a wiper according to a fourth embodiment;

FIG. 13B illustrates a side view illustrating one example of a configuration of a wiper according to a fifth embodiment;

FIG. 14 illustrates one example of a state where the wipers are caused to move down by a moving mechanism; and

FIG. 15 illustrates one example of a state where the wipers are caused to move up by the moving mechanism.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

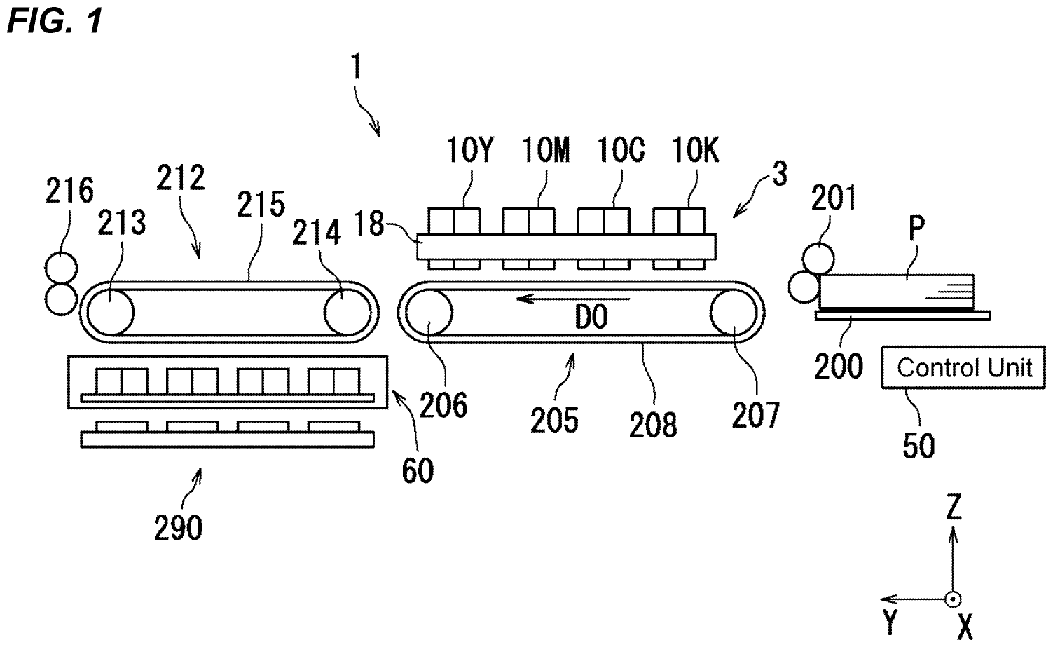

The following describes embodiments of the disclosure with reference to the drawings (FIG. 1 to FIG. 15). In the drawings, identical reference numerals are used to identical or corresponding parts and their explanations are not repeated.

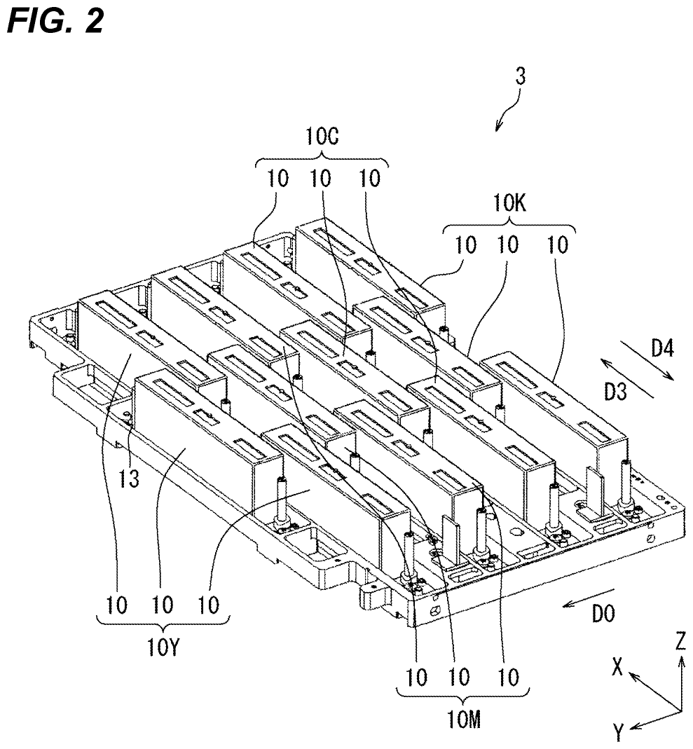

First, the following describes an ink-jet recording apparatus 1 according to the embodiment with reference to FIG. 1 and FIG. 2. FIG. 1 illustrates one example of a configuration of the ink-jet recording apparatus 1. As illustrated in FIG. 1, the ink-jet recording apparatus 1 includes a tray 200, a feeding roller 201, a first conveyance unit 205, a head unit 3, a control unit 50, a wiping device 60, a second conveyance unit 212, a discharge roller pair 216, and a cap unit 290.

The embodiment of the disclosure indicates an X-axis, a Y-axis, and a Z-axis orthogonal to one another in the drawings. The Z-axis is parallel to the vertical direction, and the X-axis and the Y-axis are parallel to the horizontal direction. The Y-axis is parallel to a conveyance direction D0 of a paper sheet P.

The tray 200 houses the paper sheets P. The tray 200 is arranged on an upstream side (the right side of FIG. 1) with respect to the first conveyance unit 205 in the conveyance direction D0 of the paper sheet P. The feeding roller 201 is arranged on a downstream end (the left end of FIG. 1) in the conveyance direction D0 of the paper sheet P. The feeding roller 201 feeds the paper sheets P housed in the tray 200 one by one to the first conveyance unit 205. The paper sheet P is equivalent to one example of “recording medium.” The paper sheet P, for example, includes a paper such as a plain paper, a copy paper, a recycled paper, a thin paper, a cardboard, and a glossy paper. “Recording medium” includes a sheet made of synthetic resin such as an Overhead Projector (OHP) sheet.

The first conveyance unit 205 includes a first drive roller 206, a first driven roller 207, and a first conveyance belt 208. The first conveyance belt 208 is bridged across the first drive roller 206 and the first driven roller 207. Rotating the first drive roller 206 by a motor (not illustrated) anticlockwise rotates the first conveyance belt 208. The paper sheet P placed on the first conveyance belt 208 is conveyed in the conveyance direction D0 (the left direction of FIG. 1). The conveyance direction D0 indicates the direction that the first conveyance belt 208 conveys the paper sheet P.

The head unit 3 forms an image on the paper sheet P. The head unit 3 is arranged opposed to a top surface of an upper side belt of the first conveyance belt 208. The head unit 3 includes a head housing 18, a line head 10Y, a line head 10M, a line head 10C, and a line head 10K. The line head 10Y discharges yellow ink. The line head 10M discharges magenta ink. The line head 10C discharges cyan ink. The line head 10K discharges black ink. The head housing 18 holds the line heads 10Y to 10K. The line heads 10Y to 10K are arranged along the conveyance direction D0 of the paper sheet P.

The second conveyance unit 212 is arranged on the downstream side (the left side of FIG. 1) with respect to the first conveyance unit 205 in the conveyance direction D0. The second conveyance unit 212 includes a second drive roller 213, a second driven roller 214, and a second conveyance belt 215. The second conveyance belt 215 is bridged across the second drive roller 213 and the second driven roller 214. Rotating the second drive roller 213 anticlockwise by the motor (not illustrated) rotates the second conveyance belt 215. The paper sheet P placed on the second conveyance belt 215 is conveyed in the conveyance direction D0 (the left direction of FIG. 1).

The discharge roller pair 216 is arranged on the downstream side (the left side of FIG. 1) with respect to the second conveyance unit 212 in the conveyance direction D0 and discharges the paper sheet P on which the image is formed to outside the ink-jet recording apparatus 1.

The paper sheet P on which the image is formed by the head unit 3 is sent to the second conveyance unit 212 and the ink attached to the surface of the paper sheet P is dried while the paper sheet P passes through the second conveyance unit 212. The wiping device 60 and the cap unit 290 are arranged under the second conveyance unit 212.

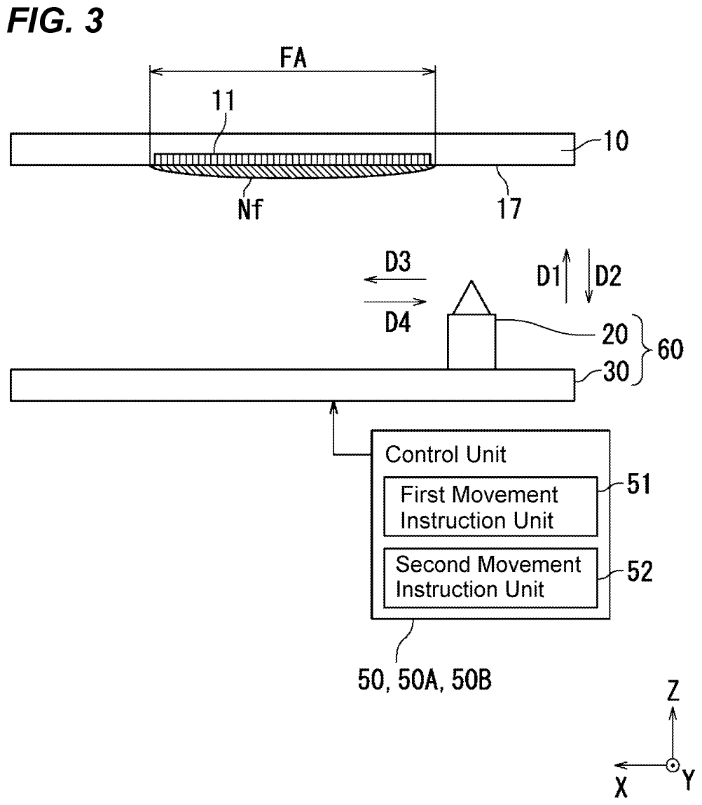

The control unit 50 controls behaviors of the ink-jet recording apparatus 1. For example, before the control unit 50 causes the wiping device 60 to wipe off the ink attached to ink discharge surfaces 17 of the line heads 10Y to 10K, that is, before execution of the wiping, the control unit 50 causes the first conveyance unit 205 to move down. The control unit 50 horizontally moves the wiping device 60, which is arranged under the second conveyance unit 212, to locate the wiping device 60 under the head unit 3 as a standby position. Consequently, the wiping device 60 is arranged between the head unit 3 and the first conveyance unit 205. As described later with reference to FIG. 3 to FIG. 9, the wiping device 60 wipes off the ink attached to the line heads 10Y to 10K.

For example, before capping of the ink discharge surfaces 17 (see FIG. 3) of the line heads 10Y to 10K, the control unit 50 horizontally moves the cap unit 290 so as to be positioned under the head unit 3. Further, the control unit 50 moves the cap unit 290 upward. Consequently, the cap unit 290 is mounted to the ink discharge surfaces 17 of the line heads 10Y to 10K. Details of the control unit 50 will be described later with reference to FIG. 3.

FIG. 2 is a perspective view illustrating the head unit 3 in the ink-jet recording apparatus 1. As illustrated in FIG. 2, the line heads 10Y to 10K each include three recording heads 10 arranged in a stagger pattern along a direction perpendicular to the conveyance direction D0 (here, the X-axis direction). The recording head 10 discharges the ink to the paper sheet P and forms the image on the paper sheet P.

Next, with reference to FIG. 1 to FIG. 3, the following describes the wiping device 60 according to the embodiment of the disclosure. FIG. 3 illustrates one example of a configuration of the wiping device 60. As illustrated in FIG. 3, the wiping device 60 includes a wiper 20 and a moving mechanism 30. The wiper 20 is mounted to the moving mechanism 30 such that a center axis of the wiper 20 in an up-down direction becomes perpendicular to a top surface of the moving mechanism 30.

The recording head 10 includes the ink discharge surface 17 on the bottom surface. A large number of nozzles 11 are open in the center of the ink discharge surface 17. The nozzles 11 discharge the ink to the paper sheet P to form the image on the paper sheet P. The nozzles 11 discharge ink Nf together with an unwanted matter inside the recording head 10 in a purge process. The ink Nf is housed in a sealed space (an ink tank (not illustrated)). This prevents a volatile component contained in the ink Nf from vaporizing. When the volatile component contained in the ink Nf touches the external air, the volatile component vaporizes.

The control unit 50 moves the wiper 20 via the moving mechanism 30. The moving mechanism 30 moves the wiper 20 according to an instruction from the control unit 50. Specifically, the moving mechanism 30 can move the wiper 20 in a moving-up direction D1, can move the wiper 20 in a wiping direction D3 or a wiping direction D4, and can move the wiper 20 in a moving-down direction D2. In this embodiment, the respective moving-up direction D1 and moving-down direction D2 run along the Z-axis and are perpendicular to the ink discharge surface 17. The respective wiping direction D3 and wiping direction D4 run along the X-axis and the ink discharge surface 17. In the following description, the moving-up direction D1 and the moving-down direction D2 are collectively referred to as the up-down direction in some cases.

According to the instruction from the control unit 50, the moving mechanism 30 moves the wiper 20 in the moving-up direction D1, the moving-down direction D2, the wiping direction D3, and the wiping direction D4. For example, to wipe the ink discharge surface 17 with the wiper 20, the moving mechanism 30 moves the wiper 20 along the ink discharge surface 17 with the wiper 20 pressed to the ink discharge surface 17. Consequently, the wiper 20 can wipe off the ink Nf discharged from the nozzles 11. The wiper 20 also wipes off the unwanted matters (for example, dirt and dust) attached to the ink discharge surface 17.

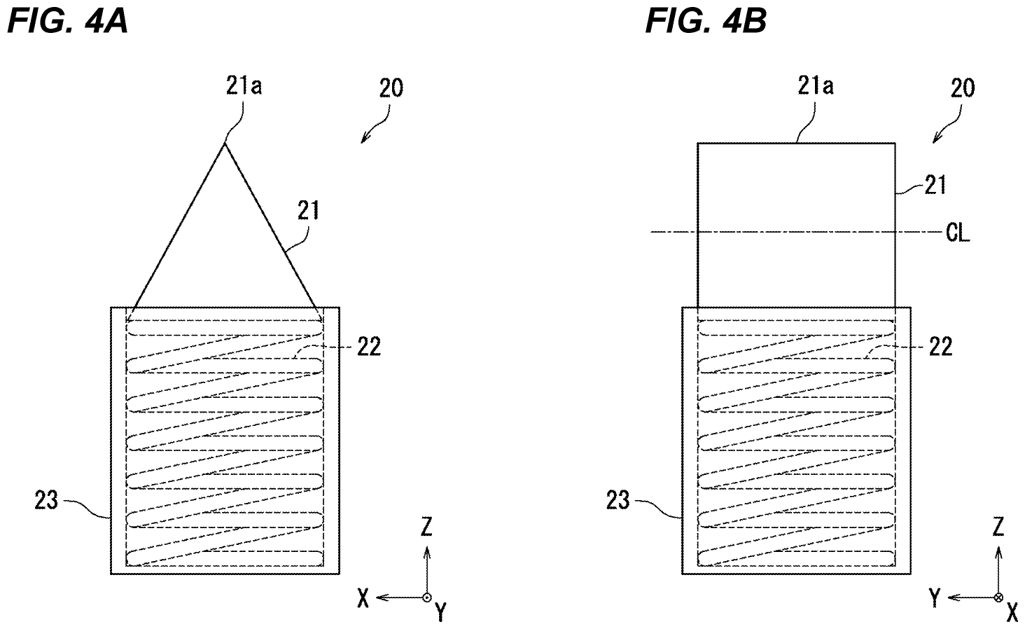

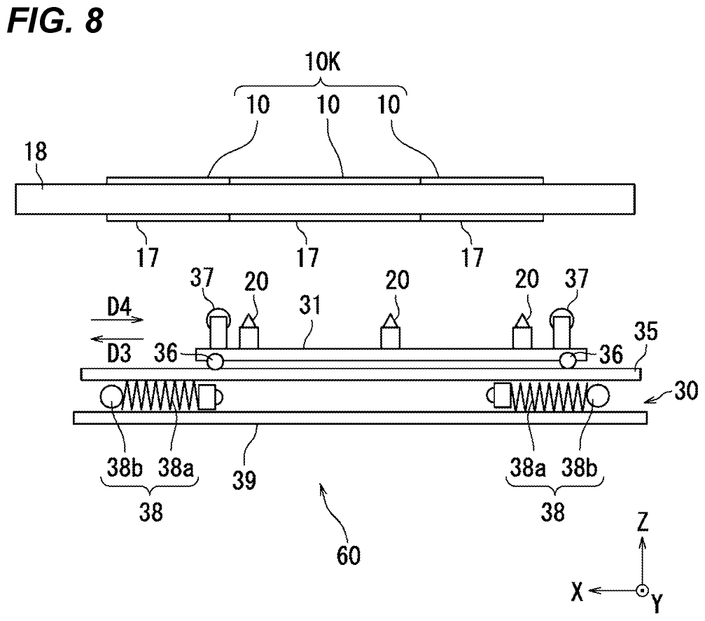

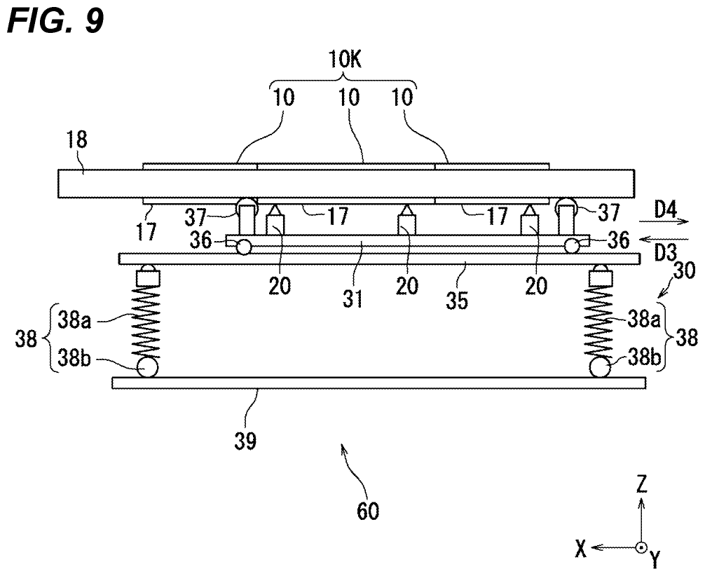

The wiper 20 wipes off the ink Nf attached to the ink discharge surface 17 of the recording head 10. Details of a configuration of the wiper 20 will be described later with reference to FIG. 4A to FIG. 7. Details of a configuration of the moving mechanism 30 will be described later with reference to FIG. 8 and FIG. 9.

Next, the following describes a functional configuration of the control unit 50. The control unit 50 includes a processor 50A and a storage unit 50B. The processor 50A includes, for example, a Central Processing Unit (CPU). The storage unit 50B may include a memory such as a semiconductor memory and may include a Hard Disk Drive (HDD). The storage unit 50B stores a control program. Execution of the control program by the processor 50A causes the processor 50A to function as a first movement instruction unit 51 and a second movement instruction unit 52.

The first movement instruction unit 51 causes the wiper 20 to move along the ink discharge surface 17 in the wiping direction D3 via the moving mechanism 30 to wipe off the ink Nf.

The second movement instruction unit 52 causes the wiper 20 to move along the ink discharge surface 17 in the wiping direction D4 via the moving mechanism 30 to wipe off the ink Nf. The following describes the case where the second movement instruction unit 52 causes the wiper 20 to move in the wiping direction D4 to wipe off the ink Nf.

### First Embodiment

Next, the with reference to FIG. 3, FIG. 4A, and FIG. 4B, the following describes the configuration of the wiper 20 according to the first embodiment. FIG. 4A and FIG. 4B illustrate one example of the configuration of the wiper 20. FIG. 4A is a side view illustrating one example of the configuration of the wiper 20. FIG. 4B is a front view illustrating one example of the configuration of the wiper 20. As illustrated in FIG. 4A and FIG. 4B, the wiper 20 includes a blade 21, a biasing member 22, and a housing member 23.

The blade 21 is formed into a columnar shape having ridge lines. Specifically, the blade 21 is formed into a regular triangular prism. The blade 21 includes three ridge line portions 21a. The ridge line portion 21a includes the ridge line. The blade 21 has a center axis CL running along the Y-axis. The ridge line portions 21a of the blade 21 in abutting contact with the ink discharge surface 17 illustrated in FIG. 3 are moved along the X-axis direction by the moving mechanism 30 illustrated in FIG. 3 and then wipe off the ink Nf attached to the ink discharge surface 17.

The blade 21 is formed of rubber. The rubber constituting the blade 21 has hardness of equal to or more than a predetermined value. The predetermined value is, for example, 30 degrees. The hardness of the rubber constituting the blade 21 is, for example, preferably 50 degrees to 80 degrees. The hardness of the rubber constituting the blade 21 is further preferably 70 degrees to 80 degrees.

The hardness of the rubber is measured by a type A durometer specified in International Organization for Standardization (ISO) 7619-1. The hardness of the rubber is measured by, for example, “ASKER Durometer Type A (product name)” manufactured by Kobunshi Keiki Co, Ltd.

The biasing member 22 biases the blade 21 in a direction perpendicular to the ink discharge surface 17 illustrated in FIG. 3. In other words, the biasing member 22 biases the blade 21 in a positive direction of the Z-axis. The biasing member 22 is, for example, formed of a coil spring. The biasing member 22 has a spring constant K of equal to or less than a predetermined value. The predetermined value is, for example, 3.0 N/mm. The spring constant K of the biasing member 22 is, for example, 0.1 N/mm to 3.0 N/mm. The spring constant K of the biasing member 22 is preferably 0.1 N/mm to 1.0 N/mm. The spring constant K of the biasing member 22 is further preferably 0.1 N/mm to 0.5 N/mm.

The housing member 23 houses the biasing member 22. The housing member 23 is formed into a closed-bottomed cylindrical shape. The housing member 23 has a bottom surface supporting a lower end of the biasing member 22. The housing member 23 has a side surface supporting the biasing member 22 to freely expand and contract. That is, the housing member 23 supports the biasing member 22 to freely expand and contract. The housing member 23 is, for example, formed of resin.

As described with reference to FIG. 3, FIG. 4A, and FIG. 4B, the biasing member 22 of the first embodiment of the disclosure biases the blade 21 to the ink discharge surface 17. Accordingly, the blade 21 moves in the biasing direction of the biasing member 22 at restoration of the wiper 20. This ensures reducing a scatter of the ink Nf.

The blade 21 is arranged such that the ridge line portions 21a of the blade 21 abut on the ink discharge surface 17. This decreases a contacted area of the blade 21 with the ink discharge surface 17. Accordingly, the wiping performance of the blade 21 can be improved.

The blade 21 is formed into a triangular prism. Accordingly, an angle formed by two surfaces between which the ridge line portion 21a is interposed can be 60 degrees or less. Accordingly, the wiping performance of the blade 21 can be further improved.

The blade 21 is formed into a regular triangular prism. Accordingly, the blade 21 can be arranged such that any one of the ridge line portions 21a among the three ridge line portions 21a of the blade 21 abuts on the ink discharge surface 17. Accordingly, when one ridge line portion 21a of the blade 21 is abraded, arranging the blade 21 such that another ridge line portion 21a of the blade 21 abuts on the ink discharge surface 17 ensures recovering the wiping performance of the blade 21. Consequently, a life of the blade 21 can be extended.

The blade 21 is formed of rubber. Accordingly, the blade 21 can be inexpensively manufactured.

The hardness of the rubber constituting the blade 21 is equal to or more than a predetermined value. The predetermined value is, for example, 50 degrees. Accordingly, an abrasion of the blade 21 caused by the wiping can be reduced. This ensures extending the life of the blade 21.

The biasing member 22 biases the blade 21 in the direction perpendicular to the ink discharge surface 17. Accordingly, the blade 21 moves in the positive direction of the Z-axis at the restoration of the wiper 20. This ensures reliably reducing the scatter of the ink Nf.

The spring constant K of the spring constituting the biasing member 22 is equal to or less than the predetermined value. The predetermined value is, for example, 1.0 N/mm. Accordingly, a deformation amount of the spring can be larger than a deformation amount of the blade 21 at wiping. Accordingly, the blade 21 can be reliably biased to the ink discharge surface 17.

The housing member 23 supports the biasing member 22 to freely expand and contract. Accordingly, the biasing member 22 can be supported to freely expand and contract by the simple configuration.

While the blade 21 is formed into the regular triangular prism shape in the first embodiment of the disclosure, the disclosure is not limited to this. The blade 21 only needs to be formed into a columnar shape including the ridge line portions 21a. For example, the blade 21 may be formed into a quadrangular prism shape. For example, the blade 21 may be formed into a columnar shape having a cross-sectional shape of an acute-angled triangle or an obtuse-angled triangle. The smaller the angle formed by the two surfaces between which the ridge line portion 21a is interposed, the more the wiping performance of the blade 21 can be improved. The larger the angle formed by the two surfaces between which the ridge line portion 21a is interposed, the life of the blade 21 can be extended. The larger the angle formed by the two surfaces between which the ridge line portion 21a is interposed, the more the scatter of the ink Nf can be reliably reduced.

While the biasing member 22 biases the blade 21 in the direction perpendicular to the ink discharge surface 17 in the first embodiment of the disclosure, the disclosure is not limited to this. The biasing member 22 only needs to bias the blade 21 to the ink discharge surface 17. For example, the blade 21 may be biased in a direction of inclining the biasing member 22 by a predetermined angle (for example, 30 degrees) with respect to the Z-axis. The predetermined angle is preferably small.

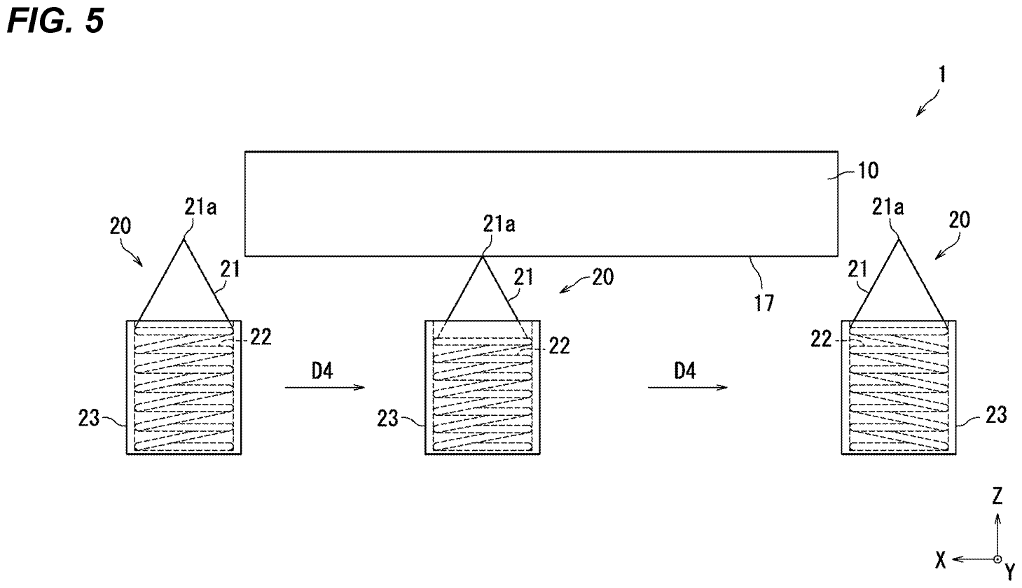

Next, with reference to FIG. 3 to FIG. 5, the following describes the behavior of the wiper 20 according to the first embodiment at the wiping. FIG. 5 is a side view illustrating one example of the behavior of the wiper 20. As illustrated in FIG. 5, the moving mechanism 30 moves the wiper 20 in the wiping direction D4 (a negative direction of the X-axis).

The wiper 20 has an initial position on the positive direction side of the X-axis with respect to the recording head 10. The wiper 20 separates from the ink discharge surface 17 at the initial position. The moving mechanism 30 moves the wiper 20 in the wiping direction D4. Then, the side surface of the blade 21 of the wiper 20 abuts on an end of the ink discharge surface 17 in the positive direction of the X-axis.

A force in the positive direction of the X-axis acts from the recording head 10 to the side surface of the blade 21. Since the side surface of the blade 21 is inclined with respect to the Z-axis, a component force in the negative direction of the Z-axis acts from the recording head 10 to the blade 21. Consequently, the biasing member 22 is compressed. The ridge line portions 21a of the blade 21 abut on the ink discharge surface 17.

With the ridge line portions 21a of the blade 21 in abutting contact with the ink discharge surface 17, the moving mechanism 30 further moves the wiper 20 in the wiping direction D4. Then, the ridge line portions 21a wipe off the ink Nf (see FIG. 3) attached to the ink discharge surface 17.

The moving mechanism 30 further moves the wiper 20 in the wiping direction D4. The ridge line portions 21a of the blade 21 of the wiper 20 abut on the end of the ink discharge surface 17 in the positive direction of the X-axis. The moving mechanism 30 further moves the wiper 20 in the wiping direction D4. The blade 21 of the wiper 20 separates from the ink discharge surface 17 in the negative direction side of the X-axis. When the blade 21 of the wiper 20 separates from the ink discharge surface 17, the biasing member 22 is restored and the blade 21 moves in the positive direction of the Z-axis.

As described with reference to FIG. 3 to FIG. 5, in the first embodiment of the disclosure, the blade 21 moves in the positive direction of the Z-axis when the wiper 20 is restored. This ensures reliably reducing the scatter of the ink Nf.

### Second Embodiment

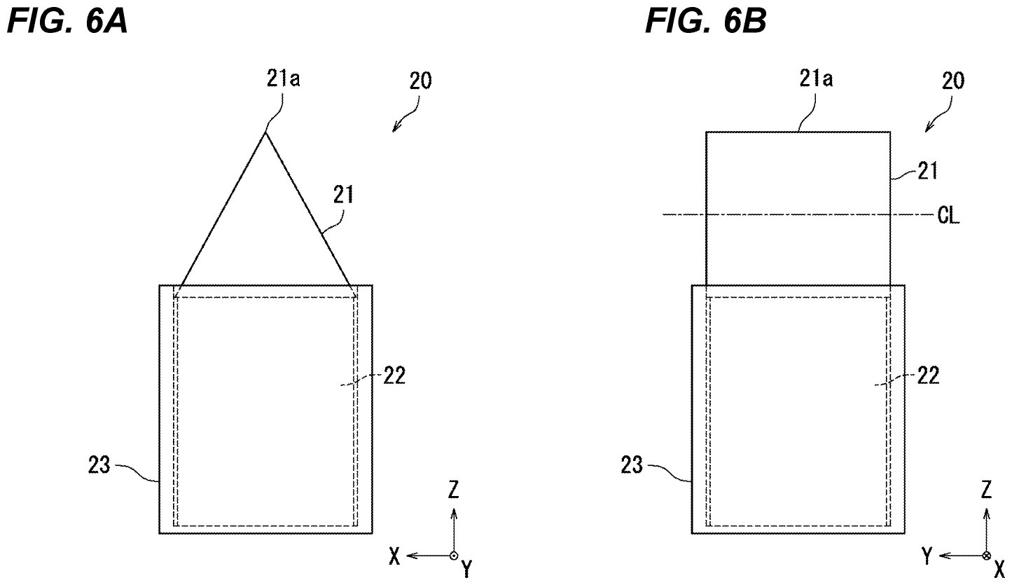

Next, with reference to FIG. 3, FIG. 4A and FIG. 4B, and FIG. 6A and FIG. 6B, the following describes a configuration of the wiper 20 according to the second embodiment. FIG. 6A and FIG. 6B illustrate one example of the configuration of the wiper 20. FIG. 6A is a side view illustrating one example of the configuration of the wiper 20. FIG. 6B is a front view illustrating one example of the configuration of the wiper 20. While the biasing member 22 of the wiper 20 illustrated in FIG. 4A and FIG. 4B (according to the first embodiment) is configured of the coil spring, the biasing member 22 of the wiper 20 illustrated in FIG. 6A and FIG. 6B (according to the second embodiment) differs in that the biasing member 22 is formed of rubber. The following mainly describes the difference in the wiper 20 illustrated in FIG. 6A and FIG. 6B from the wiper 20 illustrated in FIG. 4A and FIG. 4B.

As illustrated in FIG. 6A and FIG. 6B, the wiper 20 includes the blade 21, the biasing member 22, and the housing member 23.

The biasing member 22 biases the blade 21 in a direction perpendicular to the ink discharge surface 17 illustrated in FIG. 3. In other words, the biasing member 22 biases the blade 21 in the positive direction of the Z-axis. The biasing member 22 is, for example, formed of rubber. The rubber constituting the biasing member 22 has hardness smaller than hardness of the rubber constituting the blade 21. The hardness of the rubber constituting the biasing member 22 is, for example, equal to or less than a predetermined hardness. The predetermined hardness is, for example, 40 degrees. The hardness of the rubber constituting the biasing member 22 is preferably 20 degrees to 30 degrees.

As described with reference to FIG. 3, FIG. 4A and FIG. 4B, and FIG. 6A and FIG. 6B, in the second embodiment the disclosure, the hardness of the rubber constituting the biasing member 22 is smaller than the hardness of the rubber constituting the blade 21. Accordingly, the deformation amount of the biasing member 22 can be larger than the deformation amount of the blade 21 at wiping. Accordingly, the blade 21 can be reliably biased to the ink discharge surface 17.

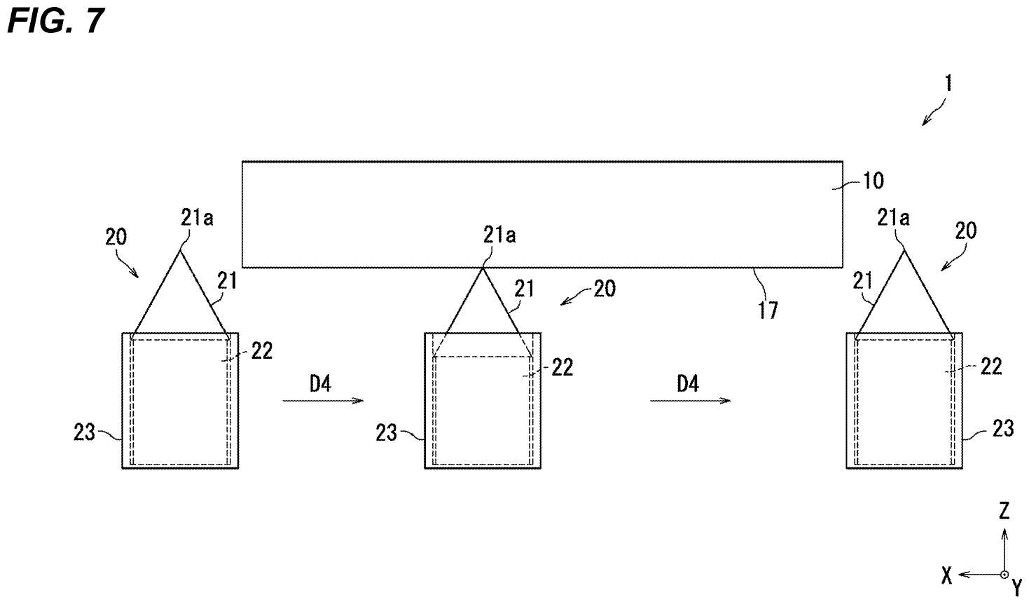

Next, with reference to FIG. 3, FIG. 4A and FIG. 4B, FIG. 6A and FIG. 6B, and FIG. 7, the following describes the behavior of the wiper 20 according to the second embodiment at the wiping. FIG. 7 is a side view illustrating one example of the behavior of the wiper 20. As illustrated in FIG. 7, the moving mechanism 30 moves the wiper 20 in the wiping direction D4.

The wiper 20 has an initial position on the positive direction side of the X-axis with respect to the recording head 10. The wiper 20 separates from the ink discharge surface 17 at the initial position. The moving mechanism 30 moves the wiper 20 in the wiping direction D4. Then, the side surface of the blade 21 of the wiper 20 abuts on the end of the ink discharge surface 17 in the positive direction of the X-axis.

A force in the positive direction of the X-axis acts from the recording head 10 to the side surface of the blade 21. Since the side surface of the blade 21 is inclined with respect to the Z-axis, a component force in the negative direction of the Z-axis acts from the recording head 10 to the blade 21. Consequently, the biasing member 22 is compressed. The ridge line portions 21a of the blade 21 abut on the ink discharge surface 17.

With the ridge line portions 21a of the blade 21 in abutting contact with the ink discharge surface 17, the moving mechanism 30 further moves the wiper 20 in the wiping direction D4. Then, the ridge line portions 21a wipe off the ink Nf (see FIG. 3) attached to the ink discharge surface 17.

The moving mechanism 30 further moves the wiper 20 in the wiping direction D4. The ridge line portions 21a of the blade 21 of the wiper 20 abut on the end of the ink discharge surface 17 in the positive direction of the X-axis. The moving mechanism 30 further moves the wiper 20 in the wiping direction D4. The blade 21 of the wiper 20 separates from the ink discharge surface 17 in the negative direction side of the X-axis. When the blade 21 of the wiper 20 separates from the ink discharge surface 17, the biasing member 22 is restored and the blade 21 moves in the positive direction of the Z-axis.

As described with reference to FIG. 3, FIG. 4A and FIG. 4B, FIG. 6A and FIG. 6B, and FIG. 7, in the embodiment of the disclosure, the blade 21 moves in the positive direction of the Z-axis when the wiper 20 is restored. This ensures reliably reducing the scatter of the ink Nf.

### Configuration of Moving Mechanism 30

Next, the following describes the moving mechanism 30 with reference to FIG. 3, FIG. 8, and FIG. 9. FIG. 8 illustrates one example of a state where the wipers 20 are caused to move down by the moving mechanism 30. FIG. 9 illustrates one example of a state where the wipers 20 are caused to move up by the moving mechanism 30. Before the execution of the wiping, the control unit 50 causes the wiping device 60 to move so as to be opposed to the line heads 10Y, 10M, 10C, and 10K. For convenience, FIG. 8 illustrates only the three wipers 20 corresponding to the three recording heads 10 provided with the line head 10K.

As illustrated in FIG. 8 and FIG. 9, the moving mechanism 30 includes a carriage 31, a support frame 35, rollers 36, gap rollers 37, a pair of elevating members 38, and a bottom portion 39. The support frame 35 supports the carriage 31. The pair of the elevating members 38 each include a lift member 38a and a shaft 38b.

The bottom portion 39 supports the support frame 35 via the elevating members 38. The elevating members 38 are arranged on the bottom portion 39 to support and move up and down the support frame 35. The shafts 38b are rotatably driven by a motor (not illustrated) to move up and down the support frame 35 via the lift members 38a. The lift members 38a are configured integrally with the shafts 38b, and rotatably driving the shafts 38b integrally rotates the lift members 38a with the shafts 38b. The rotation of the lift members 38a moves up and down the support frame 35. More specifically, the shafts 38b of the elevating members 38 are rotatably driven by the motor (not illustrated) and the lift members 38a are stood, thus moving up the support frame 35 by the lift members 38a of the elevating members 38. The shafts 38b of the elevating members 38 are rotatably driven by the motor (not illustrated) and the lift members 38a are laid down, thus moving down the support frame 35 by the lift members 38a of the elevating members 38.

The elevating members 38 support the support frame 35. The support frame 35 movably supports the carriage 31 in the X-axis direction (the wiping direction D3 and the wiping direction D4) via the rollers 36. The support frame 35 supports the rollers 36. The rollers 36 rotating on the support frame 35 moves the carriage 31 in the X-axis direction (the wiping direction D3 and the wiping direction D4).

The carriage 31 is supported by the support frame 35 via the rollers 36 and moves in the X-axis direction (the wiping direction D3 and the wiping direction D4). The gap rollers 37 and the wipers 20 are arranged on the carriage 31. When the elevating members 38 move up the support frame 35, the gap rollers 37 abut on the head housing 18 to constantly hold positions of the wipers 20 pressed to the ink discharge surfaces 17 in the up-down direction (upper limit positions). The wipers 20 are mounted to the carriage 31 such that the center axes in the Z-axis direction of the wipers 20 are perpendicular to the carriage 31.

Here, with reference to FIG. 3, FIG. 8, and FIG. 9, the following describes the behavior of the moving mechanism 30 to move up the wipers 20. First, the control unit 50 illustrated in FIG. 3 causes the motor (not illustrated) to drive to clockwise rotate the shaft 38b of the elevating member 38 arranged on the upstream side (the right side of FIG. 8) in the wiping direction D3 and anticlockwise rotate the shaft 38b of the elevating member 38 arranged on the downstream side (the left side of FIG. 8) in the wiping direction D3. Then, the lift members 38a in the laid down state are changed to be in the standing state. Consequently, as illustrated in FIG. 9, the carriage 31, the rollers 36, the gap rollers 37, and the wipers 20 move up together with the support frame 35.

As illustrated in FIG. 9, the gap rollers 37 abut on the head housing 18 to constantly hold the positions of the wipers 20 moved up and pressed to the ink discharge surfaces 17 in the up-down direction. The carriage 31 is movably supported to the support frame 35 via the rollers 36. The movement of the carriage 31 in the wiping direction D3 or the wiping direction D4 also moves the wipers 20 in the wiping direction D3 or the wiping direction D4.

The three wipers 20 corresponding to each of the line heads 10Y, 10M, and 10C behave similar to the behaviors of the three wipers 20 corresponding to the line head 10K by the moving mechanism 30.

The embodiment of the disclosure has been described above with reference to the drawings. Note that the disclosure is not limited to the embodiment described above and can be implemented in various kinds of aspects (for example, (1) and (2) described below) without departing from the gist of the disclosure. The drawings schematically illustrate respective components mainly for easy understanding. Accordingly, the thicknesses, lengths, numbers, and similar factors of the illustrated respective components are sometimes different from the actual thicknesses, lengths, numbers, and similar factors for the convenience of preparing the drawings. The shapes, dimensions, and similar factors of the respective components described in the embodiment described above are merely one example and are not particularly limited. Thus, they are variously changeable without substantially departing from the configuration of the disclosure.

(1) As described with reference to FIG. 1, while the head unit 3 includes the line head 10Y, the line head 10M, the line head 10C, and the line head 10K in the embodiment of the disclosure, the disclosure is not limited to this. The head unit 3 only needs to include at least one head.

(2) As described with reference to FIG. 4A and FIG. 4B and FIG. 6A and FIG. 6B, while the biasing member 22 of the wiper 20 is configured of the coil spring or the rubber in the embodiment of the disclosure, the disclosure is not limited to this. The biasing member 22 only needs to bias the blade 21 to the ink discharge surface 17. The biasing member 22 may be configured of an elastic member such as a leaf spring and a sponge.

Example of Implemented Aspect according to First Embodiment

The wiping device 60 according to the disclosure includes the wiper 20. The wiper 20 wipes off the ink attached to the ink discharge surface 17 of the recording head 10. The wiper 20 includes the blade 21 and the biasing member 22. The biasing member 22 biases the blade 21 to the ink discharge surface 17.

The ink-jet recording apparatus according to the disclosure includes the recording head 10 and the wiper 20. The recording head 10 discharges the ink to the recording medium to form the image on the recording medium. The wiper 20 wipes off the ink attached to the ink discharge surface 17 of the recording head 10. The wiper 20 includes the blade 21 and the biasing member 22. The biasing member 22 biases the blade 21 to the ink discharge surface 17.

### Third Embodiment

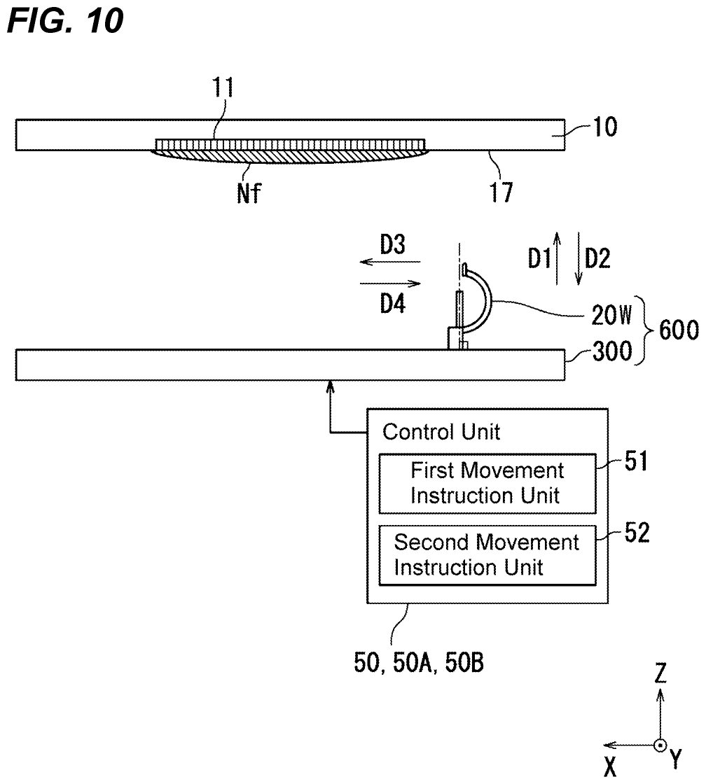

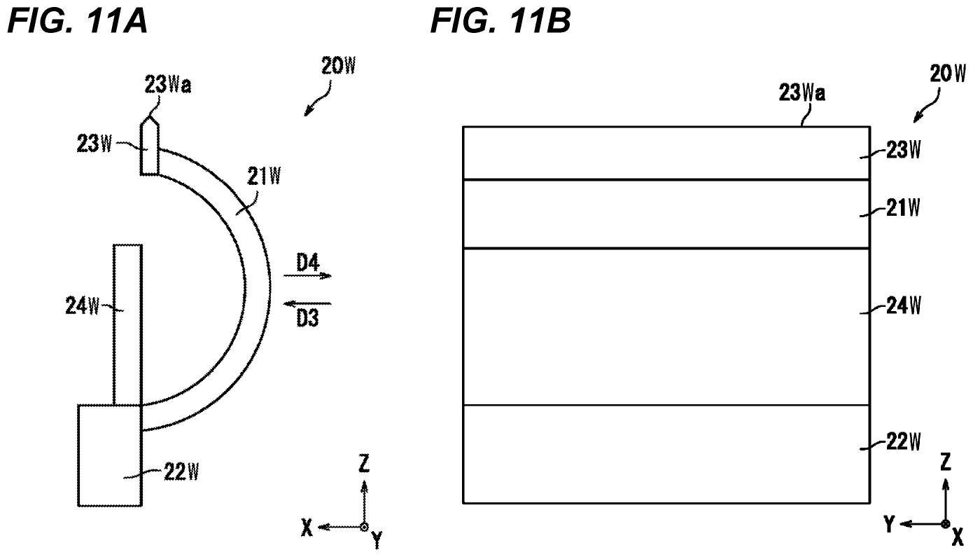

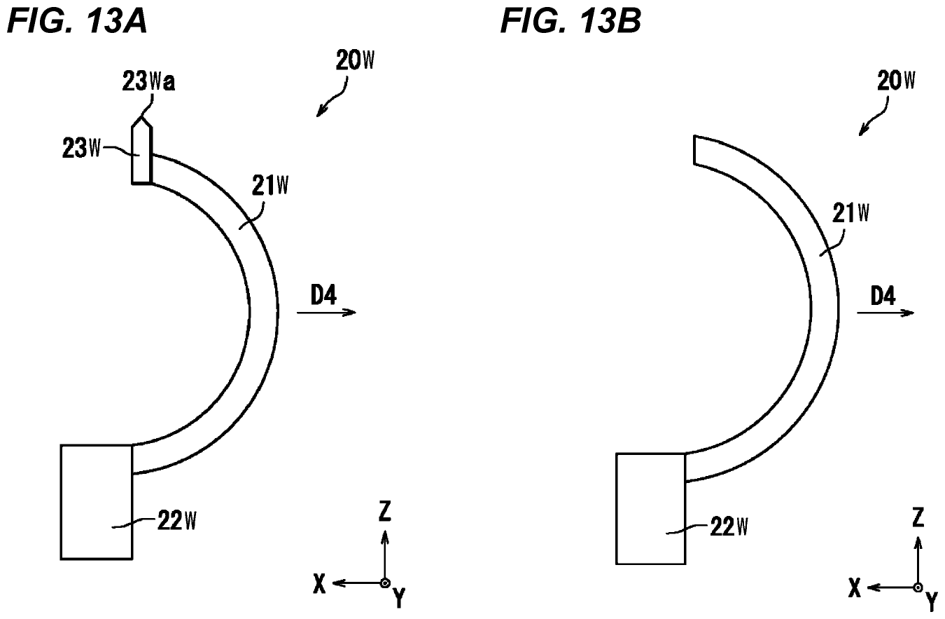

Next, the following describes a wiping device 600 according to the third embodiment of the disclosure with reference to FIG. 1, FIG. 2, and FIG. 10. FIG. 10 illustrates one example of a configuration of the wiping device 600. As illustrated in FIG. 10, the wiping device 600 includes a wiper 20W and a moving mechanism 300. The wiper 20W is mounted to the moving mechanism 300 such that a first the end portion and a second end portion of the wiper 20W run along the Z-axis direction. The first the end portion is the upper end portion of a blade 21W and the second end portion is the lower end portion of the blade 21W. Details of the blade 21W will be described later with reference to FIG. 11A and FIG. 11B and FIG. 13A and FIG. 13B.

The recording head 10 includes the ink discharge surface 17 on the bottom surface. The large number of nozzles 11 are open in the center of the ink discharge surface 17. The nozzles 11 discharge the ink to the paper sheet P to form the image on the paper sheet P. The nozzles 11 discharge the ink Nf together with an unwanted matter inside the recording head 10 in a purge process. The ink Nf is housed in a sealed space (an ink tank (not illustrated)). This prevents a volatile component contained in the ink Nf from vaporizing. When the volatile component contained in the ink Nf touches the external air, the volatile component vaporizes.

The control unit 50 moves the wiper 20W via the moving mechanism 300. The moving mechanism 300 moves the wiper 20W according to an instruction from the control unit 50. Specifically, the moving mechanism 300 can move the wiper 20W in the moving-up direction D1, can move the wiper 20W in the wiping direction D3 or the wiping direction D4, and can move the wiper 20W in the moving-down direction D2. In this embodiment of the disclosure, the respective moving-up direction D1 and moving-down direction D2 run along the Z-axis and are perpendicular to the ink discharge surface 17. The respective wiping direction D3 and wiping direction D4 run along the X-axis and the ink discharge surface 17. In the following description, the moving-up direction D1 and the moving-down direction D2 are collectively referred to as the up-down direction in some cases.

According to the instruction from the control unit 50, the moving mechanism 300 moves the wiper 20W in the moving-up direction D1, the moving-down direction D2, the wiping direction D3, and the wiping direction D4. For example, to wipe the ink discharge surface 17 with the wiper 20W, the moving mechanism 300 moves the wiper 20W along the ink discharge surface 17 with the wiper 20W pressed to the ink discharge surface 17. Consequently, the wiper 20W can wipe off the ink Nf discharged from the nozzles 11. The wiper 20W also wipes off the unwanted matters (such as dirt and dust) attached to the ink discharge surface 17.

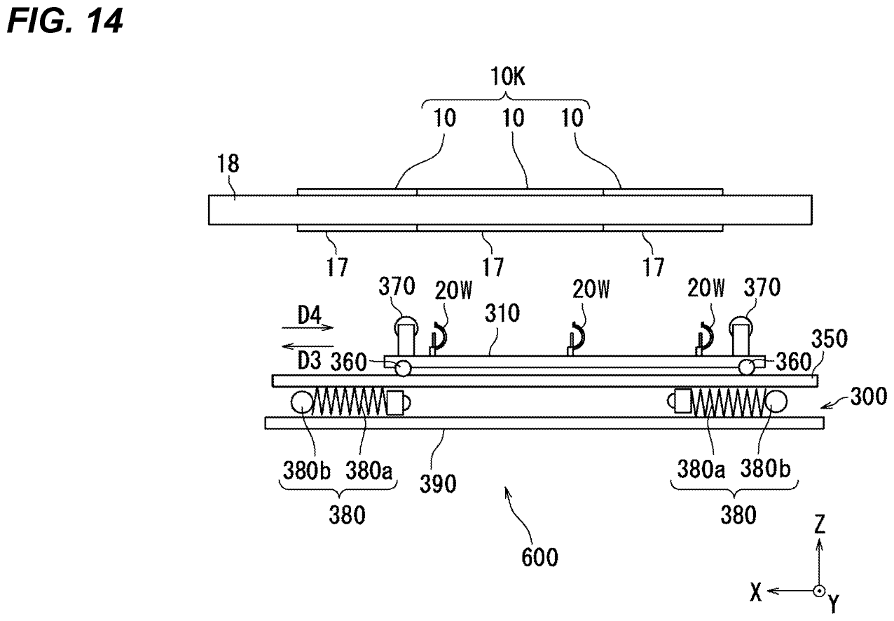

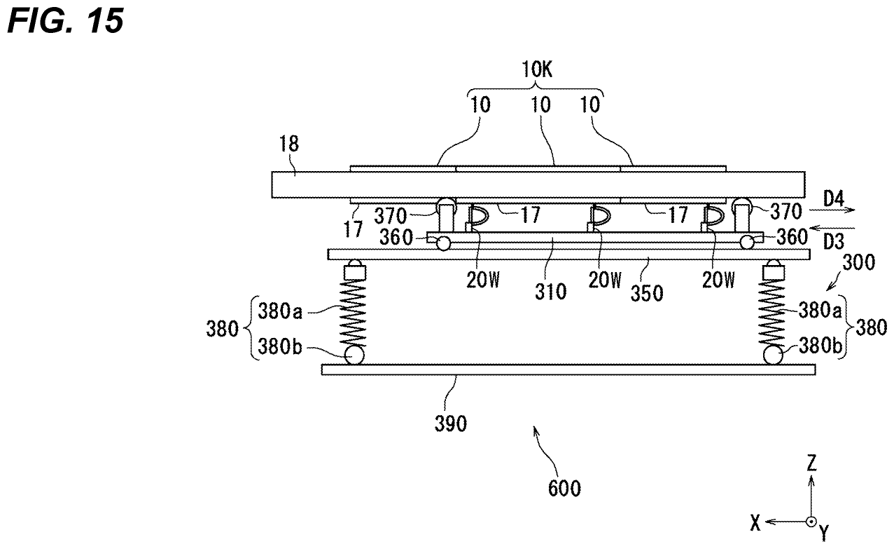

The wiper 20W wipes off the ink Nf attached to the ink discharge surface 17 of the recording head 10. Details of a configuration of the wiper 20W will be described later with reference to FIG. 11A to FIG. 13B. Details of a configuration of the moving mechanism 300 will be described later with reference to FIG. 14 and FIG. 15.

Next, the following describes a functional configuration of the control unit 50. The control unit 50 includes the processor 50A and the storage unit 50B. The processor 50A includes, for example, a Central Processing Unit (CPU). The storage unit 50B may include a memory such as a semiconductor memory and may include a Hard Disk Drive (HDD). The storage unit 50B stores a control program. Execution of the control program by the processor 50A causes the processor 50A to function as the first movement instruction unit 51 and the second movement instruction unit 52.

The first movement instruction unit 51 causes the wiper 20W to move along the ink discharge surface 17 in the wiping direction D3 via the moving mechanism 300 to wipe off the ink Nf.

The second movement instruction unit 52 causes the wiper 20W to move along the ink discharge surface 17 in the wiping direction D4 via the moving mechanism 300 to wipe off the ink Nf. The following describes the case where the second movement instruction unit 52 causes the wiper 20W to move in the wiping direction D4 to wipe off the ink Nf.

Next, the following describes the configuration of the wiper 20W according to the third embodiment with reference to FIG. 10 and FIG. 11A and FIG. 11B. FIG. 11A and FIG. 11B illustrate one example of the configuration of the wiper 20W. FIG. 11A illustrates a side view illustrating one example of the configuration of the wiper 20W. FIG. 11B illustrates a front view illustrating one example of the configuration of the wiper 20W. As illustrated in FIG. 11A and FIG. 11B, the wiper 20W includes the blade 21W, a supporting member 22W, a protruding portion 23W, and a guiding member 24W.

The blade 21W is formed of a material having elasticity. The blade 21W is, for example, formed of rubber. The rubber constituting the blade 21W has hardness equal to or less than a predetermined value. The predetermined value is, for example, 50 degrees. The hardness of the rubber constituting the blade 21W is preferably 30 degrees to 40 degrees.

The hardness of the rubber is measured by a type A durometer specified in International Organization for Standardization (ISO) 7619-1. The hardness of the rubber is measured by, for example, “ASKER Durometer Type A (product name)” manufactured by Kobunshi Keiki Co, Ltd.

The blade 21W is pressed to the ink discharge surface 17 illustrated in FIG. 10 by the moving mechanism 300 illustrated in FIG. 10. The blade 21W moved in the wiping direction D4 (the negative direction of the X-axis) by the moving mechanism 300 wipes off the ink Nf attached to the ink discharge surfaces 17.

The blade 21W has a shape easily deformed in a direction perpendicular to the ink discharge surface 17. Specifically, the blade 21W has the shape easily deformed in the direction perpendicular to the ink discharge surface 17 compared with the deformation in directions (the X-axis direction and the Y-axis direction) parallel to the ink discharge surface 17. Further, specifically, the blade 21W has a cross-sectional shape of an arc shape projecting in the wiping direction D4 (the negative direction of the X-axis). The cross section defining the cross-sectional shape is the cross section of a plane defined by the direction perpendicular to the ink discharge surface 17 and the wiping direction D4. The wiping direction D4 is equivalent to one example of “first direction.”

Further specifically, the blade 21W has a cross-sectional shape of a half-arc shape. The blade 21W has an upper end located in the direction perpendicular to the ink discharge surface 17 (Z-axis direction) with respect to a position of a lower end of the blade 21W. In other words, the lower end of the blade 21W is arranged immediately below the upper end of the blade 21W. That is, the lower end of the blade 21W has an X-coordinate matching with an X-coordinate of the upper end of the blade 21W. The blade 21W is formed into a strip shape. That is, the blade 21W is formed by curving a rectangular plate-shaped member having an approximately uniform thickness into the arc shape.

The protruding portion 23W is formed into an approximately rectangular flat plate shape and is arranged on the upper end of the blade 21W. The protruding portion 23W slides the ink discharge surface 17. The protruding portion 23W is, for example, formed of rubber. The rubber forming the protruding portion 23W has a hardness higher than hardness of the rubber forming the blade 21W. For example, the hardness of the rubber forming the protruding portion 23W is 60 degrees to 80 degrees.

The protruding portion 23W includes a ridge line portion 23Wa. The ridge line portion 23Wa includes a ridge line. The ridge line portion 23Wa is arranged along the Y-axis. The ridge line portion 23Wa is arranged on the upper end of the protruding portion 23W. The protruding portion 23W is arranged on the blade 21W such that the ridge line portion 23Wa abuts on the ink discharge surface 17.

The supporting member 22W is fixed to the moving mechanism 300. The supporting member 22W supports the blade 21W and the guiding member 24W. Specifically, the lower end of the blade 21W is fixed to the supporting member 22W. The lower end of the guiding member 24W is fixed to the supporting member 22W.

The guiding member 24W regulates the movement of the upper end of the blade 21W in the wiping direction D3. The wiping direction D3 indicates the direction opposite to the wiping direction D4. In other words, the wiping direction D3 indicates the positive direction of the X-axis. The wiping direction D3 is equivalent to one example of “second direction.”

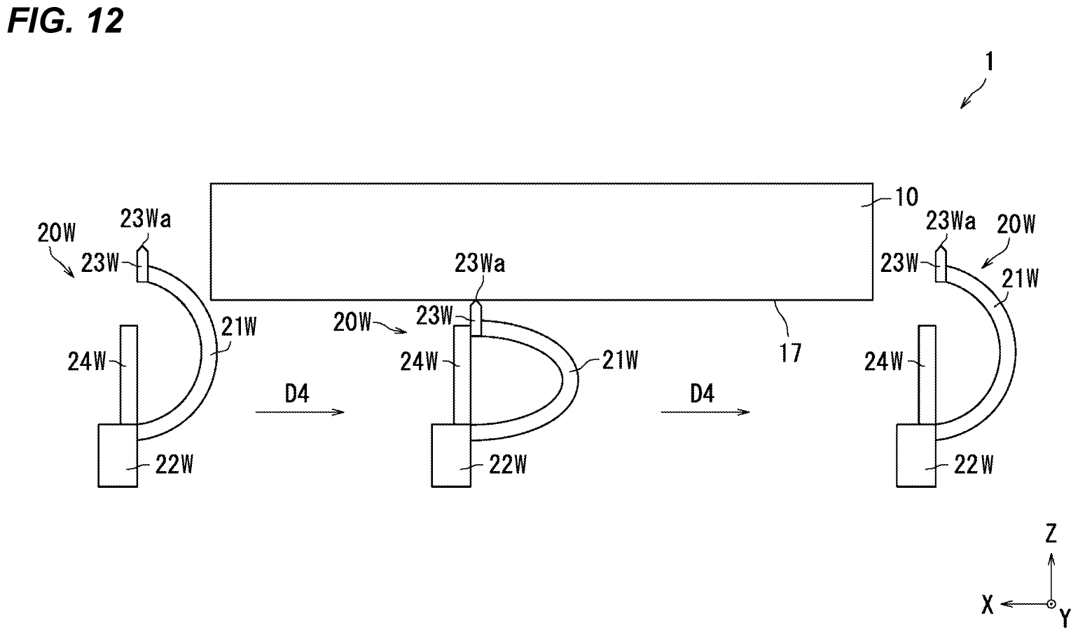

The guiding member 24W is a bar-shaped member arranged along the Z-axis. A side surface of the guiding member 24W on the downstream side (right side) in the wiping direction D4 is arranged immediately below the upper end of the blade 21W. That is, to deform the blade 21W in the direction perpendicular to the ink discharge surface 17, the upper end of the blade 21W slides the side surface on the right side of the guiding member 24W. Details of this point will be described later with reference to FIG. 12.

As described with reference to FIG. 10 and FIG. 11A and FIG. 11B, the blade 21W has the shape easily deformed in the direction perpendicular to the ink discharge surface 17 when pressed to the ink discharge surface 17 in the third embodiment of the disclosure. Accordingly, the blade 21W is restored in the direction perpendicular to the ink discharge surface 17. This ensures reducing the scatter of the ink Nf attached to the blade 21W.

The blade 21W moved in the wiping direction D4 by the moving mechanism 300 wipes off the ink Nf attached to the ink discharge surface 17. The blade 21W has the cross-sectional shape of the arc shape projecting in the wiping direction D4. The cross section defining the cross-sectional shape is the cross section having the direction perpendicular to the ink discharge surface 17 and the wiping direction D4. Accordingly, the blade 21W easily deforms in the direction perpendicular to the ink discharge surface 17. Accordingly, the scatter of the ink attached to the blade 21W can be further reduced.

The blade 21W has the cross-sectional shape of the half-arc shape. The blade 21W has an upper end located in the direction perpendicular to the ink discharge surface 17 with respect to a position of a lower end of the blade 21W. Accordingly, the blade 21W easily deforms in the direction perpendicular to the ink discharge surface 17. Accordingly, the scatter of the ink Nf attached to the blade 21W can be further reduced.

The guiding member 24W guides such that the blade 21W deforms in the direction perpendicular to the ink discharge surface 17. Accordingly, the blade 21W deforms in the direction perpendicular to the ink discharge surface 17. Accordingly, the scatter of the ink Nf attached to the blades 21W can be further reduced.

The guiding member 24W regulates the movement of the upper end of the blade 21W in the wiping direction D3. The wiping direction D3 indicates the direction opposite to the wiping direction D4. This reduces the movement of the upper end of the blade 21W in the wiping direction D3 during the wiping. Accordingly, the scatter of the ink Nf attached to the blade 21W can be further reduced.

The protruding portion 23W is arranged on the upper end of the blade 21W to slide the ink discharge surface 17. This decreases a contacted area of the blade 21W with the ink discharge surface 17. Accordingly, the wiping performance of the blade 21W can be improved.

The protruding portion 23W has a hardness higher than the hardness of the blade 21W. Therefore, the deformation amount of the protruding portion 23W is smaller than the deformation amount of the blade 21W. This further decreases a contacted area of the protruding portion 23W arranged on the blade 21W with the ink discharge surface 17. Accordingly, the wiping performance of the blade 21W can be further improved.

The protruding portion 23W is arranged on the blade 21W such that the ridge line portion 23Wa abuts on the ink discharge surface 17. This further decreases a contacted area of the blade 21W with the ink discharge surface 17. Accordingly, the wiping performance of the blade 21W can be further improved.

While the blade 21W is formed into the half arc shape in the third embodiment of the disclosure, the disclosure is not limited to this. The blade 21W only needs to have a shape easily deformed in the direction perpendicular to the ink discharge surface 17.

For example, the blade 21W may be formed to have a V shape projecting in the wiping direction D4. In this case, the smaller an angle formed by the two flat plates between which a bending portion is interposed, the easier the deformation in the direction perpendicular to the ink discharge surface 17.

For example, the blade 21W may be formed into an elliptical shape having the major axis along the X-axis direction. In this case, the larger a ratio of the major axis to the minor axis, the easier the deformation in the direction perpendicular to the ink discharge surface 17.

For example, the blade 21W may be formed into a rhombus shape. The rhombus shape has diagonal lines in the X-axis direction and the Z-axis direction. In this case, the larger a ratio of a length of the diagonal line in the X-axis direction to a length of the diagonal line in the Z-axis direction, the easier the deformation in the direction perpendicular to the ink discharge surface 17.

Next, the following describes the behavior of the wiper 20W according to the third embodiment with reference to FIG. 10 to FIG. 12. FIG. 12 illustrates a side view illustrating one example of the behavior of the wiper 20W. As illustrated in FIG. 12, at the wiping, the wiper 20W is moved in the wiping direction D4 (the negative direction of the X-axis) by the moving mechanism 300.

The wiper 20W has an initial position on the positive direction side of the X-axis with respect to the recording head 10. The wiper 20W separates from the ink discharge surface 17 at the initial position. The moving mechanism 300 moves the wiper 20W in the wiping direction D4. Then, the side surface of the blade 21W of the wiper 20W abuts on the end of the ink discharge surface 17 in the positive direction of the X-axis.

A force in the positive direction of the X-axis acts from the recording head 10 to the side surface of the blade 21W. Since the side surface of the blade 21W is inclined with respect to the Z-axis, a component force in the negative direction of the Z-axis acts from the recording head 10 to the blade 21W. Consequently, the blade 21W is compressed in the Z-axis direction. The ridge line portion 23Wa of the protruding portion 23W abuts on the ink discharge surface 17. In this state, the upper end (protruding portion 23W) of the blade 21W is in abutting contact with the side surface on the right side of the guiding member 24W, thus being supported to the guiding member 24W.

With the ridge line portion 23Wa of the protruding portion 23W in abutting contact with the ink discharge surface 17, the moving mechanism 300 further moves the wiper 20W in the wiping direction D4. Then, the ridge line portion 23Wa wipes off the ink Nf (see FIG. 10) attached to the ink discharge surface 17.

The moving mechanism 300 further moves the wiper 20W in the wiping direction D4. The ridge line portion 23Wa of the protruding portion 23W of the wiper 20W abuts on the end of the ink discharge surface 17 in the positive direction of the X-axis. The moving mechanism 300 further moves the wiper 20W in the wiping direction D4. The blade 21W of the wiper 20W separates from the ink discharge surface 17 in the negative direction side of the X-axis. When the protruding portion 23W of the wiper 20W separates from the ink discharge surface 17, the blade 21W is restored and the protruding portion 23W moves in the positive direction of the Z-axis.

As described with reference to FIG. 10 to FIG. 12, in the third embodiment of the disclosure, the blade 21W moves in the positive direction of the Z-axis when the wiper 20W is restored. This ensures reliably reducing the scatter of the ink Nf.

### Fourth Embodiment

Next, with reference to FIG. 10, FIG. 11A and FIG. 11B, and FIG. 13A, the following describes a configuration of the wiper 20W according to the fourth embodiment. FIG. 13A illustrates a side view illustrating one example of the configuration of the wiper 20W. While the wiper 20W illustrated in FIG. 11A and FIG. 11B (according to the third embodiment) includes the guiding member 24W, the wiper 20W illustrated in FIG. 13A (according to the fourth embodiment) differs in that the guiding member 24W is not provided. The following mainly describes the difference in the wiper 20W illustrated in FIG. 13A from the wiper 20W illustrated in FIG. 11A and FIG. 11B.

As illustrated in FIG. 13A, the wiper 20W includes the blade 21W, the supporting member 22W, and the protruding portion 23W.

Since the wiper 20W does not include the guiding member 24W, when the blade 21W is moved in the wiping direction D4 (the negative direction of the X-axis) by the moving mechanism 300, a sliding resistance of the ridge line portion 23Wa of the protruding portion 23W with the ink discharge surface 17 moves the distal end of the blade 21W in the negative direction of the X-axis.

The blade 21W is formed of rubber. The blade 21W has a cross-sectional shape of an arc shape projecting in the wiping direction D4 (the negative direction of the X-axis). The lower end of the blade 21W is fixed to the supporting member 22W. Accordingly, when the distal end of the blade 21W moves in the negative direction of the X-axis, an elastic restoration force of the blade 21W acts on the distal end of the blade 21W. The elastic force of the blade 21W acts in the direction of moving the distal end of the blade 21W in the positive direction of the X-axis. A position of the distal end of the blade 21W is determined at a position where the sliding resistance is balanced with the elastic restoration force.

As described with reference to FIG. 10, FIG. 11A and FIG. 11B, and FIG. 13A, since the wiper 20W does not include the guiding member 24W in the fourth embodiment of the disclosure, the configuration of the wiper 20W can be simplified. Accordingly, the wiper 20W can be inexpensively manufactured.

### Fifth Embodiment

Next, with reference to FIG. 10, FIG. 11A and FIG. 11B, and FIG. 13B, the following describes a configuration of the wiper 20W according to the fifth embodiment. FIG. 13B illustrates a side view illustrating one example of the configuration of the wiper 20W. While the wiper 20W illustrated in FIG. 13A (according to the fourth embodiment) includes the protruding portion 23W, the wiper 20W illustrated in FIG. 13B (according to the fifth embodiment) differs in that the protruding portion 23W is not provided. The following mainly describes the difference in the wiper 20W illustrated in FIG. 13B from the wiper 20W illustrated in FIG. 13A.

As illustrated in FIG. 13A, the wiper 20W includes the blade 21W and the supporting member 22W.

The wiper 20W does not include the protruding portion 23W. Therefore, the upper end of the blade 21W is in abutting contact with the ink discharge surfaces 17 and the moving mechanism 300 moves the blade 21W in the wiping direction D4 to wipe off the ink Nf attached to the ink discharge surface 17 by the blade 21W.

When the blade 21W is moved by the moving mechanism 300 in the wiping direction D4 (the negative direction of the X-axis), the sliding resistance of the upper end of the blade 21W with the ink discharge surface 17 moves the distal end of the blade 21W in the negative direction of the X-axis.

The blade 21W is formed of rubber. The blade 21W has a cross-sectional shape of an arc shape projecting in the wiping direction D4 (the negative direction of the X-axis). The lower end of the blade 21W is fixed to the supporting member 22W. Accordingly, when the distal end of the blade 21W moves in the negative direction of the X-axis, an elastic restoration force of the blade 21W acts on the distal end of the blade 21W. The elastic force of the blade 21W acts in the direction of moving the distal end of the blade 21W in the positive direction of the X-axis. A position of the distal end of the blade 21W is determined at a position where the sliding resistance is balanced with the elastic restoration force.

As described with reference to FIG. 10, FIG. 11A and FIG. 11B, and FIG. 13B, since the wiper 20W does not include the protruding portion 23W in the fourth embodiment of the disclosure, the configuration of the wiper 20W can be further simplified. Accordingly, the wiper 20W can be further inexpensively manufactured.

### Configuration of Moving Mechanism 300

Next, with reference to FIG. 10, FIG. 14, and FIG. 15, the following describes the moving mechanism 300. FIG. 14 illustrates one example of a state where the wiper 20W is caused to move down by the moving mechanism 300 illustrated in FIG. 10. FIG. 15 illustrates one example of a state where the wiper 20W is caused to move up by the moving mechanism 300. Before the execution of the wiping, the control unit 50 causes the wiping device 600 to move so as to be opposed to the line heads 10Y, 10M, 10C, and 10K. For convenience, FIG. 14 illustrates only the three wipers 20W corresponding to the three recording heads 10 provided with the line head 10K.

As illustrated in FIG. 14 and FIG. 15, the moving mechanism 300 includes a carriage 310, a support frame 350, rollers 360, gap rollers 370, a pair of elevating members 380, and a bottom portion 390. The support frame 350 supports the carriage 310. The pair of the elevating members 380 each include a lift member 380a and a shaft 380b.

The bottom portion 390 supports the support frame 350 via the elevating members 380. The elevating members 380 are arranged on the bottom portion 390 to support and move up and down the support frame 350. The shafts 380b are rotatably driven by a motor (not illustrated) to move up and down the support frame 350 via the lift members 380a. The lift members 380a are configured integrally with the shafts 380b, and rotatably driving the shafts 380b integrally rotates the lift members 380a with the shafts 380b. The rotation of the lift members 380a moves up and down the support frame 350. More specifically, the shafts 380b of the elevating members 380 are rotatably driven by the motor (not illustrated) and the lift members 380a are stood, thus moving up the support frame 350 by the lift members 380a of the elevating members 380. The shafts 380b of the elevating members 380 are rotatably driven by the motor (not illustrated) and the lift members 380a are laid down, thus move downing the support frame 350 by the lift members 380a of the elevating members 380.

The elevating members 380 support the support frame 350. The support frame 350 movably supports the carriage 310 in the X-axis direction (the wiping direction D3 and the wiping direction D4) via the rollers 360. The support frame 350 supports the rollers 360. The rollers 360 rotating on the support frame 350 moves the carriage 310 in the X-axis direction (the wiping direction D3 and the wiping direction D4).

The carriage 310 is supported by the support frame 350 via the rollers 360 and moves in the X-axis directions (the wiping direction D3 and the wiping direction D4). The gap rollers 370 and the wipers 20W are arranged on the carriage 310. When the elevating members 380 move up the support frame 350, the gap rollers 370 abut on the head housing 18 to constantly hold positions of the wipers 20W pressed to the ink discharge surfaces 17 in the up-down direction (upper limit position). The wipers 20W are mounted to the carriage 310 such that the center axes in the Z-axis direction of the wipers 20W are perpendicular to the carriage 310.

Here, with reference to FIG. 10, FIG. 14, and FIG. 15, the following describes the behavior of the moving mechanism 300 to move up the wipers 20W. First, the control unit 50 illustrated in FIG. 10 causes the motor (not illustrated) to drive to clockwise rotate the shaft 380b of the elevating member 380 arranged on the upstream side (the right side of FIG. 14) in the wiping direction D3 and anticlockwise rotate the shaft 380b of the elevating member 380 arranged on the downstream side (the left side of FIG. 14) in the wiping direction D3. Then, the lift members 380a in the laid down state are changed to be in the standing state. Consequently, as illustrated in FIG. 15, the carriage 310, the rollers 360, the gap rollers 370, and the wipers 20W move up together with the support frame 350.

As illustrated in FIG. 15, the gap rollers 370 abut on the head housing 18 to constantly hold the positions of the wipers 20W moved up and pressed to the ink discharge surfaces 17 in the up-down direction. The carriage 310 is movably supported to the support frame 350 via the rollers 360. The movement of the carriage 310 in the wiping direction D3 or the wiping direction D4 also moves the wipers 20W in the wiping direction D3 or the wiping direction D4.

The three wipers 20W corresponding to each of the line heads 10Y, 10M, and 10C behave similar to the behaviors of the three wipers 20W corresponding to the line head 10K by the moving mechanism 300.

The embodiment of the disclosure has been described above with reference to the drawings. Note that the disclosure is not limited to the embodiment described above and can be implemented in various kinds of aspects (for example, (1) and (2) described below) without departing from the gist of the disclosure. The drawings schematically illustrate respective components mainly for easy understanding. Accordingly, the thicknesses, lengths, numbers, and similar factors of the illustrated respective components are sometimes different from the actual thicknesses, lengths, numbers, and similar factors for the convenience of preparing the drawings. The shapes, dimensions, and similar factors of the respective components described in the embodiment described above are merely one example and are not particularly limited. Thus, they are variously changeable without substantially departing from the configuration of the disclosure.

(1) As described with reference to FIG. 1, while the head unit 3 includes the line head 10Y, the line head 10M, the line head 10C, and the line head 10K in the embodiment of the disclosure, the disclosure is not limited to this. The head unit 3 only needs to include at least one head.

(2) As described with reference to FIG. 11A and FIG. 11B and FIG. 13A and FIG. 13B, while the blade 21W is formed into the half arc shape in the embodiment of the disclosure, the disclosure is not limited to this. The blade 21W only needs to have a shape easily deformed in the direction perpendicular to the ink discharge surface 17. For example, the blade 21W may be formed to have a V shape projecting in the wiping direction D4. For example, the blade 21W may be formed into an elliptical shape having the major axis along the X-axis direction. For example, the blade 21W may be formed into the rhombus shape.

The disclosure is applicable to fields of the wiping device and the ink-jet recording apparatus.

### Example of Implemented Aspect According to Second Embodiment

The wiping device according to the disclosure includes the wiper. The wiper wipes off the ink attached to the ink discharge surface of the recording head. The wiper includes the blade. The blade is formed of the material having elasticity and is pressed to the ink discharge surface. The blade has the shape easily deformed in the direction perpendicular to the ink discharge surface.

The ink-jet recording apparatus according to the disclosure includes the recording head and the wiper. The recording head discharges the ink to the recording medium to form the image on the recording medium. The wiper wipes off the ink attached to the ink discharge surface of the recording head. The wiper includes the blade. The blade is formed of the material having the elasticity and pressed to the ink discharge surface. The blade has the shape easily deformed in the direction perpendicular to the ink discharge surface.

### Effects of the Disclosure

The wiping device and the ink-jet recording apparatus according to the disclosure ensure reducing the scatter of the ink.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A wiping device for wiping off ink attached to an ink discharge surface of a recording head, the wiping device comprising
a wiper that wipes off ink attached to the ink discharge surface of the recording head,
wherein the wiper is formed of a material having elasticity, and the wiper includes a blade pressed to the ink discharge surface, and
the blade has a shape easily deformed in a direction perpendicular to the ink discharge surface.

2. The wiping device according to claim 1, further comprising
a moving mechanism that supports a lower end of the blade, the moving mechanism moving the blade in a first direction,
wherein the moving mechanism moves the blade in the first direction to wipe off the ink attached to the ink discharge surface by the blade,
the blade has a cross-sectional shape of an arc shape projecting in the first direction, and
the cross section is a cross section having the direction perpendicular to the ink discharge surface and the first direction.

3. The wiping device according to claim 2,
wherein the blade has a cross-sectional shape of a half arc-shape, and
the blade has an upper end located in the direction perpendicular to the ink discharge surface with respect to a position of the lower end of the blade.

4. The wiping device according to claim 2,
wherein the wiper further includes a guiding member, and the guiding member guides such that the blade deforms in the direction perpendicular to the ink discharge surface.

5. The wiping device according to claim 4,
wherein the guiding member regulates a movement of an upper end of the blade in a second direction, and
the second direction is a direction opposite to the first direction.

6. The wiping device according to claim 1,
wherein the wiper includes a protruding portion sliding on the ink discharge surface, and
the protruding portion is arranged on an upper end of the blade.

7. The wiping device according to claim 6,
wherein the protruding portion has a hardness higher than hardness of the blade.

8. The wiping device according to claim 6,
wherein the protruding portion includes a ridge line, and
the protruding portion is arranged on the blade such that the ridge line abuts on the ink discharge surface.

9. The wiping device according to claim 1, further comprising
a moving mechanism that supports a lower end of the blade, the moving mechanism moving the blade in a first direction,
wherein the moving mechanism moves the blade in the first direction to wipe off the ink attached to the ink discharge surface by the blade,
the blade has a cross-sectional shape of an arc shape projecting in the first direction, and
the cross-sectional shape is defined by a cross section of a plane defined by the direction perpendicular to the ink discharge surface and the first direction.

10. The wiping device according to claim 6,
wherein the protruding portion is formed of rubber,
the blade is formed of rubber, and
the rubber forming the protruding portion has a hardness higher than hardness of the rubber forming the blade.

11. The wiping device according to claim 6,
wherein the protruding portion includes a ridge line portion including a ridge line, and
the protruding portion is arranged on the blade such that the ridge line portion abuts on the ink discharge surface.

12. An ink-jet recording apparatus comprising:
a recording head that discharges ink to a recording medium to form an image on the recording medium; and
a wiper that wipes off ink attached to an ink discharge surface of the recording head,
wherein the wiper is formed of a material having elasticity, and the wiper includes a blade pressed to the ink discharge surface, and
the blade has a shape easily deformed in a direction perpendicular to the ink discharge surface.
